(19) United States
(12) Patent Application Publication
(10) Pub. No.: US 2010/0163803 A1
(43) Pub. Date: Jul. 1, 2010

(54) PRODUCTION OF GAS PRODUCTS FROM RAW SYNTHESIS GAS

(76) Inventor: Harald Klein, Wolfratshausen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/527,994

(22) PCT Filed: Feb. 7, 2008
(86) PCT No.: PCT/EP08/00958

§ 371 Date: Mar. 12, 2010

(30) Foreign Application Priority Data
Feb. 21, 2007 (DE) 10 2007 008 690.5

(51) Int. Cl. C01B 3/38; B01J 8/02

(52) U.S. Cl. 252/373; 252/374; 422/187

(57) ABSTRACT

The invention relates to a process for the production of gas products from a raw synthesis gas (feedstock) that is obtained by gasification of carbon and/or heavy oil and that contains largely soot-free hydrogen (H₂) and carbon monoxide (CO) as well as sour gases (CO₂, H₂S, and COS), as well as a device for implementing the process. At least three gas products are produced in parallel from the feedstock by means of water gas shift, sour gas wash, secondary gas cleaning, and the mixing and/or recycling of process streams, whereby the gas products are pure hydrogen (31) and/or pure carbon monoxide (48) and/or ammonia synthesis gas (NH₃ syngas) (36) and/or methanol synthesis gas (MeOH syngas) (69) and/or synthesis gas for an oxo-alcohol synthesis (Oxo syngas) (62) and/or combustible gas for a gas turbine (IGCC fuel) (72) and/or synthesis gas for a Fischer-Tropsch synthesis (FT syngas) (65).

The invention relates to a process for the production of gas products from a raw synthesis gas (feedstock) that is obtained by gasification of carbon and/or heavy oil and that contains largely soot-free hydrogen (H₂) and carbon monoxide (CO) as well as sour gases (CO₂, H₂S, and COS), having the following process steps:
Adjustment of the ratio of H₂ to CO(H₂/CO ratio),
Sour gas separation by gas washing, as well as
Secondary gas cleaning by cryogenic and/or adsorptive gas separation, whereby a gas stream produced in one of the above-mentioned process steps or a partial stream, diverted from such a gas stream, with unchanged chemical composition or after mixing with at least one gas stream that is produced in the same process step or a different process step, or a partial stream, diverted from such a gas stream, is sent on to the next process step that follows or is recycled before one of the preceding process steps or is released as a gas product or residual gas (tail gas, purge gas) at the plant boundary.

In addition, the invention relates to a device for implementing the process.

In raw synthesis gases, which are produced by gasification of carbon and/or heavy oil, the ratio of the contents of hydrogen and carbon monoxide (H₂/CO ratio) is low because of the relatively small proportion of hydrogen in the carbon-containing starting substances. Because of this property, such raw synthesis gases are suitable as starting substances for the production of a number of gas products, such as, for example, hydrogen, carbon monoxide, ammonia synthesis gas (NH₃ syngas), methanol synthesis gas (MeOH syngas), synthesis gas for an oxo-alcohol synthesis (oxo syngas), combustible gas for a gas turbine (IGCC fuel) or synthesis gas for a Fischer-Tropsch synthesis (FT syngas).

According to the prior art, only a few gas products are obtained in parallel from a raw synthesis gas. Frequently, in addition to a synthesis gas product, only a hydrogen or carbon monoxide product is produced, and it is not possible to use the raw synthesis gas optimally.

The object of this invention is therefore to configure a process of the above-described type as well as a device for implementing the process so that the raw synthesis gas is better used, and the hardware and financial costs are lower than is possible according to the prior art.

On the process side, this object is achieved according to the invention in that at least three gas products are produced in parallel, whereby the gas products are pure hydrogen and/or pure carbon monoxide and/or ammonia synthesis gas (NH₃ syngas) and/or methanol synthesis gas (MeOH syngas) and/or synthesis gas for an oxo-alcohol synthesis gas (Oxo syngas) and/or combustible gas for a gas turbine (IGCC fuel) and/or synthesis gas for a Fischer-Tropsch synthesis (FT syngas).

In this connection, pure hydrogen and pure carbon monoxide are defined as hydrogen or carbon monoxide-rich gases that consist of at least 99.5% by volume of hydrogen or carbon monoxide.

Other configurations of the process according to the invention provide that
To adjust the H₂/CO ratio, the feedstock is split up into a first part and a second part, and the first part, after water vapor is added, is subjected to a water gas shift, while the second part remains unchanged, by which a shifted and an unshifted gas stream are produced.
The H₂/CO ratio in the shifted gas stream is adjusted to a specified value by adding unshifted gas and/or the H₂/CO ratio in the unshifted gas stream is adjusted to a specified value by adding shifted gas.
After the H₂/CO conditions are adjusted, both the shifted and the unshifted gas streams are purified of sulfur components and/or CO₂ in another sour gas washing, in each case, which is preferably a methanol washing.
In the secondary gas cleaning system, a gas stream is treated by pressure-change adsorption or nitrogen washing with subsequent temperature change adsorption or cryogenic gas separation (methane washing or condensation process) with subsequent temperature change adsorption.

The invention also relates to a device for producing gas products from a raw synthesis gas (feedstock) that is obtained by gasification of carbon and/or heavy oil and that contains largely soot-free hydrogen (H₂) and carbon monoxide (CO) as well as sour gases (CO₂, H₂S, and COS), having
A system for adjusting the ratio of H₂ to CO(H₂/CO ratio),
A system for sour gas separation by gas washing,
A system for secondary gas cleaning by cryogenic and/or adsorptive gas separation, as well as
Pipelines connecting the above-mentioned systems,
   whereby a gas stream that is produced in one of the above-mentioned systems or a partial stream, diverted from such a gas stream, with unchanged chemical composition or after mixing with at least one gas stream that is produced in the same system or a different system, or a partial stream, diverted from such a gas stream, can be sent on to one of the other systems or can be released as a gas product or residual gas (tail gas, purge gas) at the plant boundary.

On the hardware side, this object is achieved according to the invention in that at least three gas products are produced in parallel, whereby the gas products are pure hydrogen and/or pure carbon monoxide and/or ammonia synthesis gas (NH₃ syngas) and/or methanol synthesis gas (MeOH syngas) and/or synthesis gas for an oxo-alcohol synthesis (Oxo syngas) and/or combustible gas for a gas turbine (IGCC fuel) and/or synthesis gas for a Fischer-Tropsch synthesis (FT syngas).

Other configurations of the device according to the invention provide that
The system for adjusting the H₂/CO ratio comprises a water gas shift reactor, which contains a non-sulfur-sensitive catalyst and to which a portion of the feedstock can be fed for implementing a water gas shift (sour shift).
The system for adjusting the H₂/CO ratio comprises a water gas shift reactor, which contains a sulfur-sensitive catalyst and to which a portion of the feedstock can be fed after sulfur components are separated for implementing a water gas shift (sweet shift).
The system for adjusting the H₂/CO ratio comprises a water gas shift reactor, which contains a sulfur-sensitive catalyst and to which a portion of the feedstock can be fed after sulfur components are separated for implementing a water gas shift (sweet shift).
The system for sour gas separation comprises a first washing column, in which the portion of the feedstock that is treated by the water gas shift can be purified of sour gases; a second washing column, in which the other portion of the feedstock can be purified of sour gases; as well as a system for regeneration of charged washing agents, in which the washing agent streams that are charged in the two washing columns can be regenerated together.
The system for sour gas separation comprises a first washing column, in which the portion of the feedstock that is treated by the water gas shift can be purified of sour gases; a second washing column, in which another portion of the feedstock can be purified of sour gases; as well as a system for regeneration of charged washing agents, in which the washing agent streams that are charged in the three washing columns can be regenerated together.

The system for sour gas separation is a methanol washing in which cryogenic methanol can be used as a washing agent.
The system for gas precision cleaning comprises a pressure change adsorption, a nitrogen washing with subsequent temperature change adsorption and a cryogenic gas separation (methane washing or condensation process) with subsequent temperature change adsorption.

The desired splitting-up, mixing and recycling of gas streams make it possible to minimize the to-be-installed capacity of the secondary gas cleaning system and to use the raw synthesis gas more efficiently than is possible according to the prior art.

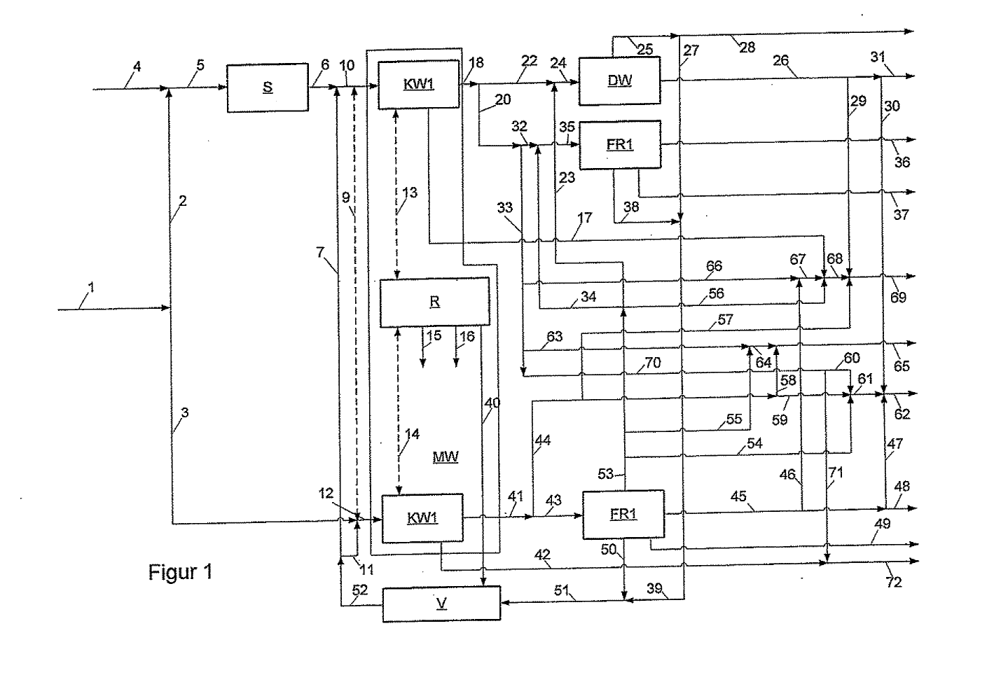

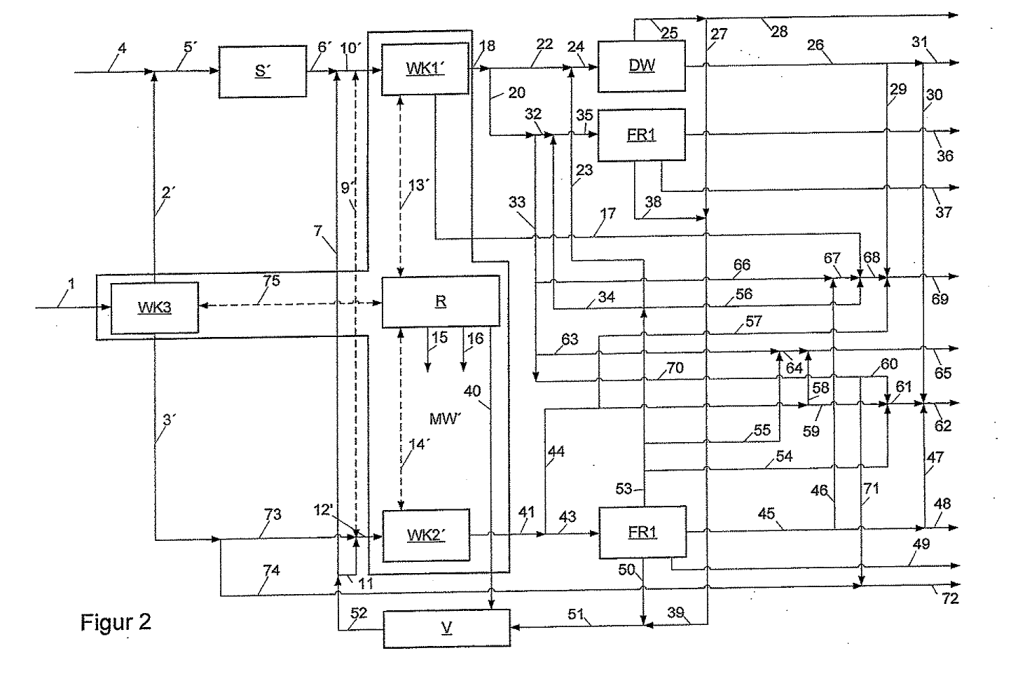

Below, the invention is to be explained in more detail based on two embodiments that are depicted diagrammatically in FIGS. 1 and 2. In the two figures, the same reference numbers refer to the same plant components or process streams.

In the two embodiments, a raw synthesis gas (feedstock) that is obtained by gasification of carbon and/or heavy oil and that contains largely soot-free hydrogen (H₂) and carbon monoxide (CO) as well as sour gases (CO₂, H₂S) is reacted by water gas shift, gas purification, gas separation and the mixing of process streams in a broad spectrum of gas products. The process and systems used for this purpose are fully developed process technologies, as they have been used for a long time in other connections in the industry. The main difference in the two embodiments is in the type of water gas shift, which is implemented in the first embodiment as a so-called sour shift and in the second embodiment as a so-called sweet shift.

In the embodiment that is depicted in FIG. 1, the feedstock fed via line 1 for adjusting the H₂/CO ratio is split up into two partial streams 2 and 3. The partial stream 2 is concentrated with water vapor 4 and introduced via line 5 into the sour shift reactor S, in which the carbon monoxide is converted with water largely into hydrogen and carbon dioxide. The converted gas is drawn off via line 6 from the sour shift reactor S and combined with the gas stream 7—further described below—to form the gas stream 10, which ultimately feeds the first washing column WK1 of the methanol washing MW that comprises two washing columns and is purified there of carbon dioxide and sulfur components (e.g., H₂S, COS). The partial stream 3 is combined with the gas stream 11 (further described below) to form the gas stream 12, which subsequently is fed to the second washing column WK2 of the methanol washing MW, and is purified there of carbon dioxide and sulfur components. The two washing columns WK1 and WK2 are designed for optimum purification of the two gas streams 10 and 12 under normal operation. To be able to react in a flexible manner to changes in product amounts, it is possible, via the line 9, to add a portion of the gas stream 12 to the gas stream 10 or a portion of the gas stream 10 to the gas stream 12.

The two washing columns WK1 and WK2 of the methanol washing MW are in each case designed with at least two washing sections, in which sulfur components and CO₂ are separated from the gases to be washed in a largely selective manner. The regeneration system R is commonly used to regenerate the charged methanol washing agent. To this end, as indicated by the two arrows 13 and 14 shown as dotted lines, charged methanol washing agent is drawn off from the two washing columns WK1 and WK2 and, after removal of undesired substances in the regeneration system R, purified methanol washing agent is returned to the two washing columns WK1 and WK2. In addition to a residual gas 15, a sulfur-rich gas 16 and the gas stream 40 that mainly consists of H₂, CO and CO₂, are drawn off from the regeneration system R. While the sulfur-rich gas 16 is sent to a Claus unit (not shown) to recover sulfur, the gas stream 40 is fed to the compressor V.

Two largely CO- and sulfur-free, hydrogen-rich gas streams 17 and 18 are drawn off from the washing column WK 1. While the gas stream 17 that is drawn off to a point before the CO₂ washing section has CO₂ in an elevated concentration, the gas stream 18 is largely CO₂-free. The gas stream 18 is then split up into the two partial streams 20 and 22. By the combination with the hydrogen-rich gas stream 23 (further described below), the gas stream 24 is formed from the gas stream 22, and the gas stream 24 is then introduced into the pressure change adsorption device DW and separated there into the gas stream 25 and the pure hydrogen stream 26. From the gas stream 25, the H₂-rich residual gas stream 28 is produced by separation of the gas stream 27 and is then released at the plant boundary. The pure hydrogen stream 26 from the pressure change adsorption system DW is sent on as a pure hydrogen product 31 after the two gas streams 29 and 30 are separated.

The largely CO- and sulfur-free, hydrogen-rich gas stream 20 is split up into the two partial streams 32 and 33. Partial stream 32 is mixed with the hydrogen-rich gas stream 34 to a point before it is introduced as part of the thus formed gas stream 35 into the secondary gas cleaning system FR1 that comprises a cryogenic nitrogen washing and a temperature change adsorption system. In the secondary gas cleaning system FR1, an ammonia synthesis gas (NH₃ syngas) 36 is produced from the gas stream 35. Moreover, in the secondary gas cleaning system FR1, an H₂— and CO-containing residual gas 37, which is sent to the plant boundary, as well as an H₂-rich residual gas 38, which is combined with the partial stream 27 of the gas stream 25 to form the gas stream 39, are produced.

Two largely sulfur-free CO- and H₂-rich gas streams 41 and 42 are drawn off from the washing column WK2. While the gas stream 42, which is drawn off to a point before the CO₂ washing section, has CO₂ in an elevated concentration, the gas stream 41 is largely CO₂-free. The gas stream 41 is then split up into the two partial streams 43 and 44, from which one partial stream 43 is introduced into the secondary gas cleaning system FR2 that comprises a cryogenic gas separation system and a temperature change adsorption system. In the secondary gas cleaning system FR2, pure carbon monoxide 45 is produced from the partial stream 43, and said pure carbon monoxide is sent on as pure hydrogen product 48 after the two gas streams 46 and 47 are separated. Moreover, in the secondary gas cleaning system FR2, a residual gas 49 that contains hydrogen and carbon monoxide and that is sent to the plant boundary, as well as an H₂- and CO-rich residual gas 50, which is combined with the gas stream 39 to form the gas stream 51 and is sent into the compressor V, are produced. The gas stream 52 that is compressed in the compressor V is split up into two partial streams 7 and 11 and recycled to a point before the methanol washing MW to increase the H₂ and CO yields.

The gas stream 53, which is also produced in the secondary gas cleaning system FR2 and which for the most part consists of hydrogen, is split up into the partial streams 54, 55, 56, 23 and 34, which are subsequently added to other gas streams. The partial stream 54 is combined with the gas stream 59 that is produced from the H₂- and CO-rich gas stream 44 by diverting the partial streams 57 and 58 and the gas stream 60, which is produced by separating the gas stream 71 from the gas stream 70 that is diverted from the H₂-rich gas stream 33, to form the gas stream 61, which then, after gas streams 30 and 47 that have hydrogen—or carbon monoxide product quality are added, is sent on as synthesis gas for an oxo-alcohol synthesis (oxo syngas) 62. The partial stream 55 is combined with the gas stream 63 that is diverted from the H₂-rich gas stream 33 to form the gas stream 64 that is then sent on, after the gas stream 58 that is diverted from the H₂- and CO-rich gas stream 44 is added, as a synthesis gas for a Fischer-Tropsch synthesis (FT syngas) 65. The partial stream 56 is mixed with the gas stream 67, which is produced from the combination of the gas stream 66, diverted from the H₂-rich gas stream 33, with the gas stream 46 that has the CO product quality, and the CO₂-rich gas stream 17 from the washing column WK1 to form the gas stream 68, which then, after the gas stream 57 that is diverted from the H₂- and CO-rich gas stream 44 and the gas stream 29 that has H₂ product quality are added, is sent on as a methanol synthesis gas (MeOH syngas) 69.

The substance flow 42, containing carbon monoxide, carbon dioxide and hydrogen, from the washing column WK2 is combined with the H₂-rich gas stream 71 and released as combustible gas for a gas turbine (IGCC fuel) 72 at the plant boundary.

In the embodiment depicted in FIG. 2, the feedstock, fed via line 1, for separating sulfur components (e.g., H₂S, COS) is sent into the third washing column WK3 of the methanol washing MW′ that comprises three washing columns. The sulfur-free feedstock is then split up into the two partial streams 2′ and 3′ to adjust the H₂/CO ratio. The partial stream 2′ is concentrated with water vapor 4 and introduced via line 5′ into the sweet shift reactor S′, in which the carbon monoxide is converted with water largely to form hydrogen and carbon dioxide. The converted gas is drawn off via line 6′ from the sweet shift reactor S′ and combined with the gas stream 7—further described below—to form gas stream 10′, which finally is fed to the first washing column WK1′ of the methanol washing MW′ and is purified of carbon dioxide there. The partial stream 3′ is split up into the two partial streams 73 and 74, of which one 73 is combined with the gas stream 11 (further described below) to form the gas stream 12′, is subsequently fed to the second washing column WK2′ of the methanol washing MW′ and is purified of carbon dioxide there. The two washing columns WK1′ and WK2′ are designed for an optimum purification of the two gas streams 10′ and 12′ under normal operation. To be able to react in a flexible manner to changes in product amounts, it is possible, via line 9′, to add a portion of the gas stream 12′ to the gas stream 10′ or a portion of the gas stream 10′ to the gas stream 12′.

For regeneration of the charged methanol washing agent, the three washing columns WK1′, WK2′ and WK3′ of the methanol washing MW′ commonly use the regeneration device R. To this end, as indicated by the three arrows 13′, 14′, and 75 shown as dotted lines, charged methanol washing agent is drawn off from the three washing columns WK1′, WK2′ and WK3, and, after undesirable substances are removed in the regeneration system R, purified methanol washing agent returns to the three washing columns WK1′, WK2′ and WK3. In addition to a residual gas 15, a sulfur-rich gas 16 and a gas stream 40 that consists primarily of H₂, CO and CO₂ are drawn off from the regeneration device R. While the sulfur-rich gas 16 of a Claus unit (not shown) is sent to recover sulfur, the gas stream 40 is fed to the compressor V.

Two largely CO- and sulfur-free, hydrogen-rich gas streams 17 and 18 are drawn off from the washing column WK1′. While the gas stream 17 that is drawn off to a point before the CO₂ washing section has CO₂ in an elevated concentration, the gas stream 18 is largely CO₂-free. The gas stream 18 is then split up into the two partial streams 20 and 22. By the combination with the hydrogen-rich gas stream 23 (further described below), the gas stream 24 is formed from the gas stream 22, and the gas stream 24 is then introduced into the pressure change adsorption system DW and is separated there into the gas stream 25 and the pure hydrogen stream 26. The H₂-rich residual gas stream 28 is produced from the gas stream 25 by separation of the gas stream 27, and said residual gas stream 28 is then released at the plant boundary. The pure hydrogen stream 26 from the pressure change adsorption system DW is sent on as a pure hydrogen product 31 after the two gas streams 29 and 30 are separated.

The largely CO- and sulfur-free, hydrogen-rich gas stream 20 is split up into the two partial streams 32 and 33. Partial stream 32 is mixed with the hydrogen-rich gas stream 34, before it is sent as part of the thus formed gas stream 35 into the secondary gas cleaning system FR1 that comprises a cryogenic nitrogen washing and a temperature change adsorption system. In the secondary gas cleaning system FR1, an ammonia synthesis gas (NH₃ syngas) 36 is produced from the gas stream 35. Moreover, in the secondary gas cleaning system FR1, a residual gas 37 that contains H₂ and CO and that is fed to the plant boundary, as well as an H₂-rich residual gas 38, which is combined with the partial stream 27 of the gas stream 25 to form the gas stream 39, are produced.

A largely sulfur-free and CO₂-free, CO- and H_{z}-rich gas stream 41 is drawn off from the washing column WK2′ and split up into the two partial streams 43 and 44, of which one 43 is introduced into the secondary gas cleaning system FR2 that comprises a cryogenic gas separation system and a temperature change adsorption system. In the secondary gas cleaning system FR2, pure carbon monoxide 45 is produced from the partial stream 43 and is sent on as a pure hydrogen product 48, after the two gas streams 46 and 47 are separated. Moreover, in the secondary gas cleaning system FR2, a residual gas 49 that contains hydrogen and carbon monoxide and that is sent to the plant boundary, as well as an H₂- and CO-rich residual gas 50, which is combined with the gas stream 39 to form the gas stream 51 and is sent into the compressor V, are produced. The gas stream 52 that is compressed in the compressor V is split up into the two partial streams 7 and 11 and recycled to increase the H₂ and CO yields to a point before the methanol washing MW′.

The gas stream 53 that is also produced in the secondary gas cleaning system FR2, which consists for the most part of hydrogen, is split up into the partial streams 54, 55, 56, 23 and 34, which are subsequently added to other gas streams. The partial stream 54 is combined with the gas stream 59 that is produced from the H₂- and CO-rich gas stream 44 by diverting the partial streams 57 and 58, and the gas stream 60, which is produced by separation of the gas stream 71 from the gas stream 70 that is diverted by the H₂-rich gas stream 33, to form the gas stream 61, which then, after gas streams 30 and 47 that have hydrogen- or carbon monoxide product quality are added, is sent on as synthesis gas for an oxo-alcohol synthesis (oxo syngas) 62. The partial stream 55 is combined with the gas stream 63 that is diverted from the H₂-rich gas stream 33 to form the gas stream 64, which then, after the gas stream 58 that is diverted from the H₂- and CO-rich gas stream 44 is added, is sent on as synthesis gas for a Fischer-Tropsch synthesis (FT syngas) 65. The partial stream 56 is mixed with the gas stream 67, which is produced from the combination of the gas stream 66, which is diverted from the H₂-rich gas stream 33, with the gas stream 46 that has the CO product quality, and the CO₂-rich gas stream 17 from the washing column WK1 to form the gas stream 68, which then, after the gas stream 57 that is diverted from the H₂- and CO-rich gas stream 44 and the gas stream 29 that has the H₂ product quality are added, is sent on as methanol synthesis gas (MeOH syngas) 69.

The substance flow 74 that contains carbon monoxide, carbon dioxide and hydrogen from the washing column WK3 is combined with the H₂-rich gas stream 71 and released as combustible gas for a gas turbine (IGCC fuel) 72 at the plant boundary.

1. A process for the production of gas products from a raw synthesis gas (feedstock) that is obtained by gasification of carbon and/or heavy oil and that contains largely soot-free hydrogen (H₂) and carbon monoxide (CO) as well as sour gases (CO₂, H₂S, and COS), having the following process steps:
Adjustment of the ratio of H₂ to CO(H₂/CO ratio),
Sour gas separation by gas washing, as well as
Secondary gas cleaning by cryogenic and/or adsorptive gas separation,
whereby a gas stream produced in one of the above-mentioned process steps or a partial stream, diverted from such a gas stream, with unchanged chemical composition or after mixing with at least one gas stream that is produced in the same process step or a different process step, or a partial stream, diverted from such a gas stream, is sent on into a next process step that follows or is recycled to the point before one of the preceding process steps or is released as a gas product or residual gas (tail gas, purge gas) at the plant boundary, characterized in that at least three gas products are produced in parallel, whereby the gas products are pure hydrogen (31) and/or pure carbon monoxide (48) and/or ammonia synthesis gas (NH₃ syngas) (36) and/or methanol synthesis gas (MeOH syngas) (69) and/or synthesis gas for an oxo-alcohol synthesis (Oxo syngas) (62) and/or combustible gas for a gas turbine (IGCC fuel) (72) and/or synthesis gas for a Fischer-Tropsch synthesis (FT syngas) (65).

2. A process according to claim 1, wherein to adjust the H₂/CO ratio, the feedstock (1) is split up into a first part (2) and a second part (3), and the first part (2), after water vapor (4) is added, is subjected to a water gas shift (sour shift) (S), while the second part (3) remains unchanged, by which a shifted gas stream (6) and an unshifted gas stream (3) are produced.

3. A process according to claim 1, wherein the feedstock (1) is largely purified of sulfur components by physical gas scrubbing (WK3) and the feedstock that is purified of sulfur components is split up into a first part (2′) and a second part (3′) for adjusting the H₂/CO ratio, whereby the first part (2′), after water vapor (4) is added, is subjected to a water gas shift (sweet shift) (S′), while the second part remains unchanged, by which a shifted gas stream (6′) and an unshifted gas stream (3′, 73) are produced.

4. A process according to claim 2, wherein both the shifted gas stream (6, 6′) and the unshifted gas stream (73) are purified of sulfur components and/or CO₂ in a methanol sour gas scrubber (WK1, WK1′, WK2, WK2′).

5. A process according to claim 1, wherein in the secondary gas cleaning system, a gas stream is separated by pressure change adsorption (DW) or nitrogen scrubbing with subsequent temperature change adsorption (FR1) or cryogenic gas separation (methane scrubbing or condensation process) with subsequent temperature change adsorption (FR2).

6. Apparatus for producing gas products from a raw synthesis gas (feedstock) (1) that is obtained by gasification of carbon and/or heavy oil and that contains largely soot-free hydrogen (H₂) and carbon monoxide (CO) as well as sour gases (CO₂, H₂S, and COS), having
A system for adjusting the ratio of H₂ to CO(H₂/CO ratio),
A system for sour gas separation by gas scrubbing,
A system for secondary gas cleaning by cryogenic and/or adsorptive gas separation, and
Pipelines connecting the above-mentioned systems, so that
a gas stream that is produced in one of the above-mentioned systems or a partial stream, diverted from such a gas stream, with unchanged chemical composition or after mixing with at least one gas stream that is produced in the same system or a different system, or a partial stream, diverted from such a gas stream, can be sent on to one of the other systems or can be released as a gas product or residual gas (tail gas, purge gas) at the plant boundary, further comprising means for producing at least three gas products in parallel, whereby the gas products are pure hydrogen (31) and/or pure carbon monoxide (48) and/or ammonia synthesis gas (NH₃ syngas) (36) and/or methanol synthesis gas (MeOH syngas) (69) and/or synthesis gas for an oxo-alcohol synthesis (Oxo syngas) (62) and/or combustible gas for a gas turbine (IGCC fuel) (72) and/or synthesis gas for a Fischer-Tropsch synthesis (FT syngas) (65).

7. Apparatus according to claim 6, wherein the system for adjusting the H₂/CO ratio comprises a water gas shift reactor (S), which contains a non-sulfur-sensitive catalyst and to which a portion of the feedstock (2, 5) can be fed for implementing a water gas shift (sour shift).

8. Apparatus according to claim 6, wherein the system for adjusting the H₂/CO ratio comprises a water gas shift reactor (S′), which contains a sulfur-sensitive catalyst and to which a portion of the feedstock (2′, 5′) can be fed after sulfur components are separated for implementing a water gas shift (sweet shift).

9. Apparatus according to claim 7, wherein the system for sour gas separation (MW) comprises a first scrubbing column (WK1), in which the portion (6) of the feedstock that is treated by the water gas shift can be purified of sour gases; a second scrubbing column (WK2), in which the other portion of the feedstock (3) can be purified of sour gases; as well as a system for regeneration of charged scrubbing agent (R), in which the scrubbing agent streams that are charged in the two scrubbing columns can be regenerated together.

10. Apparatus according to claim 8, wherein the system for sour gas separation comprises a first scrubbing column (WK3), in which sulfur compounds can be removed from the entire feedstock (1); a second scrubbing column (WK1′), in which the portion of the sulfur-free feedstock (6′) that is treated by water gas shift is purified of carbon monoxide; a third scrubbing column (WK2′), in which another portion of the sulfur-free feedstock (73) is purified of carbon monoxide; as well as a system for regeneration of charged scrubbing agent (R′), in which the scrubbing agent streams that are charged in the three scrubbing columns can be regenerated together.

11. Apparatus according to claim 9, wherein the system for sour gas separation (MW, MW′) is cryogenic methanol, scrubbing further comprising means for transporting cryogenic methanol can be used as a scrubbing agent.

12. Apparatus according to claim 6, wherein the system for secondary gas cleaning comprises a pressure change adsorption (DW) system, a nitrogen scrubbing system coupled with a temperature change adsorption (FR1) system and/or a cryogenic gas separation (methane scrubbing or condensation) system coupled) with a temperature change adsorption system (FR2).
